(19) United States
(12) Patent Application Publication
(10) Pub. No.: US 2014/0078972 A1
(43) Pub. Date: Mar. 20, 2014

(54) Method and Apparatus for Signaling Demodulation Reference Signals

(71) Applicant: Stefano Sorrentino, Solna (SE)

(72) Inventor: Stefano Sorrentino, Solna (SE)

(73) Assignee: TELEFONAKTIEBOLAGET LM ERICSSON (PUBL), Stockholm (SE)

(21) Appl. No.: 13/696,494

(22) PCT Filed: Oct. 23, 2012
(86) PCT No.: PCT/SE2012/051139

§ 371 Date: Nov. 6, 2012

Related U.S. Application Data
(60) Provisional application No. 61/556,550, filed on Nov. 7, 2011.

(51) Int. Cl. H04L 5/00; H04W 72/04

(52) U.S. Cl. CPC H04L 5/0048; H04W 72/04
USPC 370/329

(57) ABSTRACT

The teachings herein disclose device-side and network-side methods (400, 700) and apparatuses (16, 18, 20) for advantageously controlling demodulation reference symbol, “DMRS”, transmissions by wireless devices (20) operating in a wireless communication network (10), so as to reduce or minimize interference between the DMRS transmissions from different wireless devices (20). In one aspect, such improvements in interference control are achieved by, at individual ones of one or more wireless devices (20) operating in the network (10), optionally disabling cyclic shift hopping within individual repetitions of an orthogonal cover code applied to DMRS transmissions by the wireless device (20).

### RELATED APPLICATIONS

This application claims priority from the U.S. provisional patent application filed on 7 Nov. 2011 and assigned App. No. 61/556,550, and which is incorporated by reference herein.

### TECHNICAL FIELD

The present invention generally relates to wireless communication networks and particularly relates to the use of demodulation reference signals in such networks.

### BACKGROUND

Channel estimation is required for coherent demodulation of a received radio signal, where “coherence” denotes detection of the received signal phase. It is known to transmit so-called demodulation reference signals, “RS”, to allow for coherent detection at the receiver. As a non-limiting example, user equipment configured to operate in wireless communication networks based on the Long Term Evolution, “LTE”, standard transmit RS on the uplink, “UL”, to allow for coherent detection at the receiving eNodeBs of their uplink data transmissions on the Physical Shared Uplink Channel, “PUSCH”.

The RS from different UEs within the same cell potentially interfere with each other. Further, assuming synchronized networks, the RS transmitted by UEs in one cell may interfere with the RS transmitted by UEs in a neighboring cell. To limit the level of interference between RS, different techniques have been introduced in different releases of the LTE standard. Currently, the LTE standard assumes that RS transmitted by different UEs within the same cell are orthogonal with respect to one another, while the RS transmitted by UEs in one cell are semi-orthogonal with respect to the RS transmitted by UEs in a neighboring cell. (Note, however, that orthogonal RS can be achieved for aggregates of cells through the use of so called “sequence planning”).

To understand the above interference mitigations, it is first helpful to understand that in LTE each RS is characterized by a “group index” and a “sequence index,” which together define the so called “base sequence.” Base sequences are cell-specific in Rel-8/9/10, and they are a function of the cell ID, where each cell in the network has a unique ID. Different base sequences are semi-orthogonal. The RS for a given UE is only transmitted on the same bandwidth of PUSCH, and the base sequence is correspondingly generated so that the RS is a function of the PUSCH bandwidth. For each subframe, two RSs are transmitted, one per slot.

Rel-8/9 of the LTE standard achieves RS orthogonality within the same cell through the use of a cyclic shift, “CS”, in which UEs using the same base sequence each time-wise apply a different cyclic shift to the base sequence. There are twelve different cyclic shifts defined in Rel-8/9, out of which only eight can be dynamically indicated in each scheduled subframe. This operation is referred to herein as “cyclic shift hopping” or “CS hopping” for short. In a current LTE-based example, the randomization pattern used by UEs for cyclic shift hopping is cell-specific. For each UE in a cell, a different cyclic shift offset is in general applied in each slot, with the offset known at the UE and at the receiving eNodeB, so that it can be compensated at the eNodeB side during channel estimation.

RS orthogonalization also may be achieved through the use of Orthogonal Cover Codes, “OCC”, which are individually applied by UEs to their RS transmissions, in addition to or in alternative to the use of cyclic shift hopping. The use of OCC is a multiplexing technique based on orthogonal time domain codes. In the LTE context, a UE transmits its reference signal as two reference symbols sent in the successive two slots comprising an LTE subframe. Here, an appropriate OCC has a code length, also referred to as block length, of two, e.g., [1-1] or [1 1], and the UE applies the OCC to the two reference symbols in the subframe.

While base-sequences are assigned in a semi-static fashion, the cyclic shift and OCC are UE-specific and dynamically assigned as part of the scheduling grant for each UL PUSCH transmission. Cyclic shift randomization is always enabled in LTE and its use generates random, cell-specific cyclic shift offsets per slot. The pseudo-random cyclic shift pattern—i.e., the CS hopping pattern—is a function of the base sequence index and the cell ID and is thus cell-specific. Sequence hopping and group hopping, “SGH”, are base sequence index randomization techniques, which operate on a slot level with a cell-specific pattern, which in turn is a function of the cell ID and sequence index. Notably, for Rel-8/9 UEs, SGH can be enabled/disabled on a cell-specific basis, and for Rel-10 UEs, SGH can be enabled in a UE specific fashion.

Interference mitigation among reference signals becomes decidedly more complicated in the context of the multi-antenna techniques introduced in LTE Rel-10. While such techniques, including linear precoding for the simultaneous transmission of multiple data streams in parallel on different “spatial multiplexing layers,” significantly increase data rates, they also lead to more complex RS transmission and interference-mitigation scenarios. In particular, whenever a UE transmits on multiple layers, it must transmit a unique reference signal on each layer, to permit coherent detection at the receiving eNodeB(s).

The mitigation of interference between the RS from multiple UEs becomes particularly complicated in certain scenarios, e.g., in Coordinated Multi-Point, “CoMP”, deployments, transmissions are coordinated across UEs in a cluster of cells, meaning that different base sequences are involved in the RS transmissions from the UEs served by the CoMP cluster. Even when performing Multi-User Multiple-Input-Multiple-Output, “MU-MIMO”, within the same cell becomes more complicated when simultaneously scheduled UEs have only partly overlapping transmission bandwidths.

However, the almost-certain presence of a mix of UEs from Rel-8/9/10 and beyond in the same network emphasizes the need to seamlessly co-schedule such UEs, independently of their specific release. Notably, however, MU-MIMO is not efficient in Rel-8/9/10 in conjunction with SGH, if the UEs paired for multi-user service are assigned different base sequences or different bandwidths, because neither OCC nor cyclic shifts are effective in such scenario and only semi-orthogonality can be achieved between their respective reference signals. One known approach to that issue is based on disabling SGH in a UE-specific way for some of the Rel-10 UEs. However, SGH can only be disabled in a cell-specific way for Rel-8/9 UEs, thus implying cell-specific SGH disabling even for Rel-10 UEs. However, such disabling results in a severe degradation of inter-cell interference control. Furthermore, SGH disabling allows for MU-MIMO within a cell but not between cells associated with different cell-IDs and base sequences for UL DMRS.

One might consider assigning the same base sequence and, consequently, the same SGH pattern, to interfering cells such as by assigning the same base sequence to a macro cell in a heterogeneous network, “het-net”, and to all of the pico cells overlaying that macro cell. However, that approach reduces SGH randomization, leads to unpredictably large interference peaks in reference signals when UEs with the same base sequence are scheduled on partly overlapping bandwidths, and results in reference-signal capacity limitations, because only cyclic shifting and OCC may be employed for orthogonalizing different reference signals over the aggregated cells.

### SUMMARY

The teachings herein disclose device-side and network-side methods and apparatuses for advantageously controlling demodulation reference symbol, “DMRS”, transmissions by wireless devices operating in a wireless communication network, so as to reduce or minimize interference between the DMRS transmissions from different wireless devices. In one aspect, such improvements in interference control are achieved by, at individual ones of one or more wireless devices operating in the network, optionally disabling cyclic shift hopping within individual repetitions of an orthogonal cover code applied to DMRS transmissions by the wireless device.

Correspondingly, an example wireless device includes radio and processing circuitry and is configured to implement a method transmitting demodulation reference symbols that includes selectively disabling cyclic shift hopping within repetitions of an orthogonal cover code that is applied to demodulation reference symbol transmissions by the wireless device. When cyclic shift hopping within repetitions of the orthogonal cover code is disabled, the wireless device applies a same cyclic shift value to individual demodulation reference symbols transmitted within each repetition of the orthogonal cover code, so that all demodulation reference symbols transmitted for one repetition of the orthogonal cover code have the same cyclic shift value applied to them. When cyclic shift hopping within repetitions of the orthogonal cover code is enabled, the wireless device applies a different cyclic shift value to individual demodulation reference symbols transmitted within each repetition of the orthogonal cover code, so that all demodulation reference symbols transmitted for one repetition of the orthogonal cover code have different cyclic shift values applied to them.

On the network side, an example base station or other network node includes radio circuitry and processing circuitry that are configured to perform a method of controlling DMRS transmissions by a wireless device. In particular, the network node in an example embodiment is configured to implement a method that includes determining whether a wireless device should disable cyclic shift hopping within repetitions of an orthogonal cover code applied by the wireless device DMRS transmissions by the wireless device. Correspondingly, the method further includes sending signaling to the wireless device (20), to cause the wireless device to disable cyclic shift hopping within said repetitions of the orthogonal cover code.

Of course, the present invention is not limited to the above brief summary. Those of ordinary skill in the art will recognize additional features and advantages from the following detailed description of example embodiments, and from the accompanying drawings.

### BRIEF DESCRIPTION OF THE DRAWINGS

FIG. 1 is a block diagram of one embodiment of a wireless communication network in which one or more network nodes and wireless devices are configured according to the method(s) taught herein for generating and transmitting demodulation reference symbols.

FIG. 2 is a block diagram of one embodiment of a user equipment, “UE”, or other wireless device, such as may be used in the network of FIG. 1.

FIG. 3 is a block diagram of one embodiment of functional processing elements implemented in an example wireless device.

FIG. 4 is a logic flow diagram of one embodiment of a processing method for demodulation reference symbol, “DMRS”, transmission from a wireless device.

FIG. 5 is a block diagram of one embodiment of an example base station, such as may be used in the network of FIG. 1.

FIG. 6 is a block diagram of one embodiment of functional processing elements implemented in an example base station.

FIG. 7 is a logic flow diagram of one embodiment of a processing method for controlling DMRS transmissions from a wireless device, such as may be implemented in a base station or other network node.

FIGS. 8A and 8B are signal diagrams of slot and subframe structures associated with DMRS transmissions in some embodiments described herein.

### DETAILED DESCRIPTION

Note that although terminology from 3GPP LTE-Advanced has been used in this disclosure to exemplify the invention, this should not be seen as limiting the scope of the invention to only the aforementioned system. Other wireless systems, including WCDMA, WiMax, UMB and GSM, may also benefit from exploiting the ideas covered within this disclosure.

Also note that terminology such as base station and UE should be considered non-limiting and does in particular not imply a certain hierarchical relation between the two; in general “base station” could be considered as device 1 and “UE” device 2, and these two devices communicate with each other over some radio channel. Further, unless otherwise noted, the term “UE” has general applicability and may be understood as being interchangeable with the term “wireless device.”

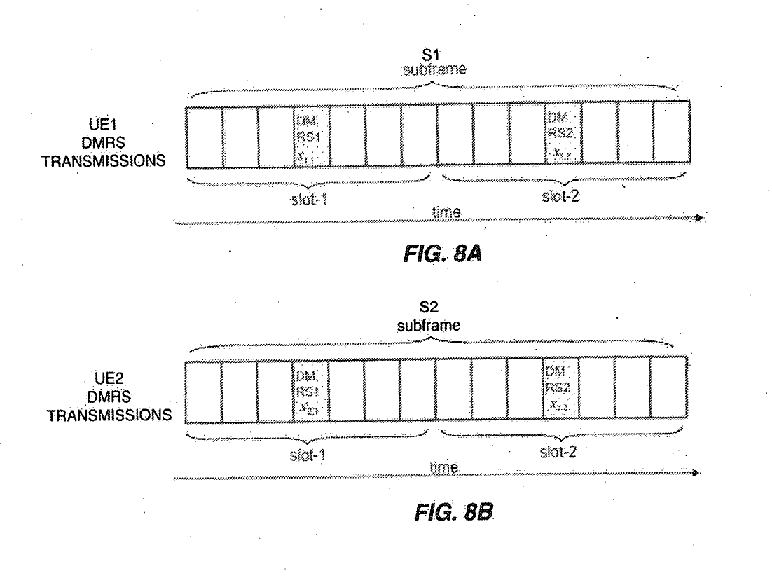

In an example context involving Long Term Evolution or LTE, a method disclosed herein involves transmitting demodulation reference symbols on an LTE slot/subframe basis, where a basic demodulation reference symbol transmission involves the transmission of two demodulation reference symbols, one such symbol in each of the two slots comprising the subframe in question. One may refer ahead momentarily to FIGS. 8A and 8B, which graphically depict demodulation reference symbols—also denoted as “DMRS”—being transmitted within the indicated slots of an LTE subframe. In particular, FIG. 8A illustrates demodulation reference symbols x_{1,1} and x_{1,2}, as transmitted in first and second slots of a given subframe by a first wireless device, while FIG. 8B illustrates demodulation reference symbols x_{2,1} and x_{2,2}, as transmitted in the same first and second slots by a second wireless device.

According to one embodiment of the method, a wireless device, such as UE, generates a demodulation reference symbol and transmits the demodulation reference symbol in a first slot of a subframe. The UE then transmits the same demodulation reference symbol in a second slot of the subframe. Stated differently, the demodulation reference symbol that was transmitted in the first slot is repeated in the second slot. Notably, the same cyclic shift value is applied for each transmission of the demodulation reference symbol. As such, it will be understood that, for the time frame at issue with respect to the repeated DMRS transmission, CS hopping is “disabled” inasmuch as the same cyclic shift value—the same cyclic shift offset—is applied for both transmissions of the repeated demodulation reference symbol.

In more detail, the example wireless device transmits a demodulation reference symbol in a first slot of a subframe using a base sequence and a cyclic shift offset. The wireless device then transmits a demodulation reference symbol in a second slot of the subframe using the same base sequence and the same cyclic shift offset. The implementation complexity of the proposed scheme is marginal, and it allows substantial reuse of the SGH sequences implemented in Rel-8/9/10 UEs.

Returning to FIG. 8A again, consider a subframe, S1, transmitted by a wireless device that is configured for LTE operation and denominated as “UE1”. This device is provided with two demodulation reference symbols, respectively one per slot. Without loss of generality, in the following a time-domain representation of the signals is provided, but equivalent principles may be applied for frequency-domain processing.

Let s1 be the DMRS base sequence for slot-1 and s2 the DMRS base sequence for slot-2. In case of multi-antenna transmission, FIG. 8A represents the DMRS associated to a given transmission layer. Consider now a second LTE subframe, S2, as in FIG. 8B, where the DMRS base sequences for the two slots are respectively s3 and s4. S2 is transmitted by another wireless device, denominated as “UE2”. When SGH is enabled for the two UEs by the involved network, subframes S1 and S2 have different base sequences in each slot, where s1, s2, s3 and s4 are semi-orthogonal base sequences pseudo-randomly chosen from a set of predefined base sequences.

On top of optional SGH, each UE is provided with CS-hopping, which may not be disabled according to LTE Rel-8/9/10. Consider, e.g., the case where the two UEs are co-scheduled on partly overlapping bandwidth. As an example from prior art, consider the case where UE1 and UE2 belong to different cells and are not assigned the same base sequence, e.g., one non-limiting example is that UE1 belongs to a macro cell and UE2 to a pico cell in a het-net LTE scenario. Assume, without limiting the generality of these teachings, that the following cyclic shift and OCC values are assigned:

UE1: CS1,1 on slot-1, CS1,2 on slot-2, OCC1=[1 1], and

UE2: CS2,1 on slot-1, CS2,2 on slot-2, OCC2=[1 −1].

The term α_{CS}_{_{a,b}} denotes the phase shift corresponding to the CS for user “a” on slot “b”, and the α_{CS}_{_{1,1}}−α_{CS2,1}≠α_{CS}_{_{1,2}}−α_{CS}_{_{2,2}}, as typically configured in an LTE network to achieve CS randomization for different cells.

The signal for the DMRS on slot-1 for UE1 is

x_{1,1}(n)=s₁(n) [symbol] δ(n−T_{1,1}).

The signal for the DMRS on slot-2 for UE1 is

x_{1,2}(n)=s₂(n) [symbol] δ(n−T_{1,2}).

The signal for the DMRS on slot-1 for UE2 is

x_{2,1}(n)=s₃(n) [symbol] δ(n−T_{2,1}).

The signal for the DMRS on slot-2 for UE2 is

x_{2,2}(n)=s₄(n) [symbol] δ(n−T_{2,2}).

where [symbol] indicates circular convolution over the support of sₓ (n) and δ(n) is a Dirac's delta centered on sample 0. T_{a,b} represents the delay (in samples) due to the cyclic shift in frequency domain CS_{a,b}. Due to the properties of CAZAC sequences employed for base sequences, it holds that s₁ [symbol] s₁*=δ(n).

Now, let h₁ be the channel impulse response from UE1 and let h₂ be the channel impulse response from UE2 to the network access point. Further, assume that the channels are constant over the two slots. Disregarding for simplicity the noise terms, the received signal y1 on slot-1 reads as y₁(n)=h₁(n) [symbol] x_{1,1}(n)+h₂(n) [symbol] x_{2,1}(n), while the signal at slot-2 reads as

y₂(n)=h₁(n) [symbol] x_{1,2}(n)+h₂(n) [symbol] x_{2,2}(n).

As an example, consider the channel estimator for UE1, based on a matched filter. The output of the matched filter is:

$$\begin{matrix}{g}_{1} ( n ) = \frac{{x}_{1 , 1} ( - n ) * ⊗ {y}_{1} ( n ) + {x}_{1 , 2} ( - n ) * ⊗ {y}_{2} ( n )}{2} \\ = {h}_{1} ( n ) + {h}_{2} ( n ) ⊗ \frac{{x}_{1 , 1} ( - n ) * ⊗ {x}_{2 , 1} ( n ) + {x}_{1 , 2} ( - n ) * ⊗ {x}_{2 , 2} ( n )}{2} ,\end{matrix}$$

where

$${h}_{2} ( n ) ⊗ \frac{{x}_{1 , 1} ( - n ) * ⊗ {x}_{2 , 1} ( n ) + {x}_{1 , 2} ( - n ) * ⊗ {x}_{2 , 2} ( n )}{2}$$

represents inter-UE interference and is in general non-zero. Consequently, the legacy, prior art LTE solution is not able to cancel DMRS interference in the analyzed scenario in the general case because of the term x_{1,1}(−n)* [symbol] x_{2,1}(n)+x_{1,2}(−n)* [symbol] x_{2,2}(n).

One possible circumvention of this problem is to repeat the same base sequence on both slots of the subframe as discussed in 3GPP contribution R1-110298, “On UL DM-RS SGH Disabling”. With such a solution it becomes possible to support orthogonal DMRS for co-scheduled UEs within the same cell, i.e., for UEs provided with the same CS hopping pattern. However, it is still not possible to guarantee inter-cell DMRS orthogonality. The mathematical proof of that is found in the following:

$${x}_{1 , 1} ( - n ) * ⊗ {x}_{2 , 1} ( n ) + {x}_{1 , 2} ( - n ) * ⊗ {x}_{2 , 2} ( n ) = ( {s}_{1} ( - n ) δ ( n + {T}_{1 , 1} ) ) * ⊗ ( {s}_{2} ( n ) δ ( n - {T}_{2 , 1} ) ) + ( {s}_{1} ( - n ) δ ( n + {T}_{1 , 2} ) ) * ⊗ ( {s}_{2} ( n ) δ ( n - {T}_{2 , 2} ) ) = {s}_{1} ( - n ) * {s}_{2} ( n ) ( δ ( n + {T}_{1 , 1} ) ⊗ δ ( n - {T }_{2 , 1} ) + δ ( n + {T }_{1 , 2} ) ⊗ δ ( n - {T}_{2 , 2} ) ) ,$$

which shows that the interference term is not canceled in the general case.

In addressing these and other issues, some embodiments taught herein comprise modifying the mapping of demodulation reference symbols to slots in order to allow DMRS orthogonality for Multi-User Multiple-Input-Multiple-Output, “MU-MIMO”, applications. Similarly, orthogonality for MU-MIMO also may be obtained between wireless devices belonging to different cells.

Some embodiments comprise repeating the same DMRS symbol on both slots of a given subframe. In case OCC is applied, it is applied on top of such repeated symbol. For example, in case the OCC pattern [1-1] is applied, it holds x_{1,2}=−x_{1,1}. The demodulation reference symbols transmitted may differ between different subframes if base sequence and/or group hopping pattern is applied. Interference is cancelled, as shown in further following details, wherein:

x_{1,1}(−n)* [symbol] x_{2,1}(n)+x_{1,2}(−n)* [symbol] x_{2,2}(n)=x_{1,1}(−n)* [symbol] x_{2,1}(n)−x_{1,1}(−n)* [symbol] x_{2,1}(n)=0.

In one example, the demodulation reference symbol transmitted by the UE and repeated on both slots, excluding the effect of OCC, is derived from the demodulation reference symbol that would have been transmitted by the UE for one of the slots according to the LTE Rel-8/9/10 standard. By doing so, the solution may be implemented by reusing most of the implementation for previous LTE releases.

Assuming that two UEs in a MU-MIMO configuration repeat the same demodulation reference symbol on both slots and that one of them employs OCC=[1 1] and the other one OCC=[1 −1], the demodulation reference symbols from the two UEs are orthogonal with respect to each other after matched filtering for channel estimation.

In this example of OCC, the length of the OCC is two, i.e., the OCC used to cover the DMRS transmissions includes two elements and, in particular, a respective element in the OCC is applied to a respective one of the two demodulation reference symbols transmitted in a subframe. In this regard, it will be understood that the OCC is repeatedly applied to successive DMRS transmissions. In this non-limiting example, with two demodulation reference symbols transmitted as a pair in the two slots of a subframe, each OCC repetition covers such a pair of demodulation reference symbols.

In another example, the same pseudo-random CS-hopping offset and the same pseudo-random base sequence are optionally repeated on both slots within a subframe, and pseudo-randomly changed between subframes.

In another example, when a modified pseudo-random base sequence hopping pattern is used, such that the same base sequence is repeated on both slots within a subframe, the CS hopping is implicitly disabled. Here, disabling CS hopping means that the same cyclic shift value is employed in both slots of a subframe. Notably, however, the cyclic shift value may be varied across subframes, e.g., pseudo-randomly updated across different subframes while being held fixed for the DMRS transmissions within individual ones of the subframes.

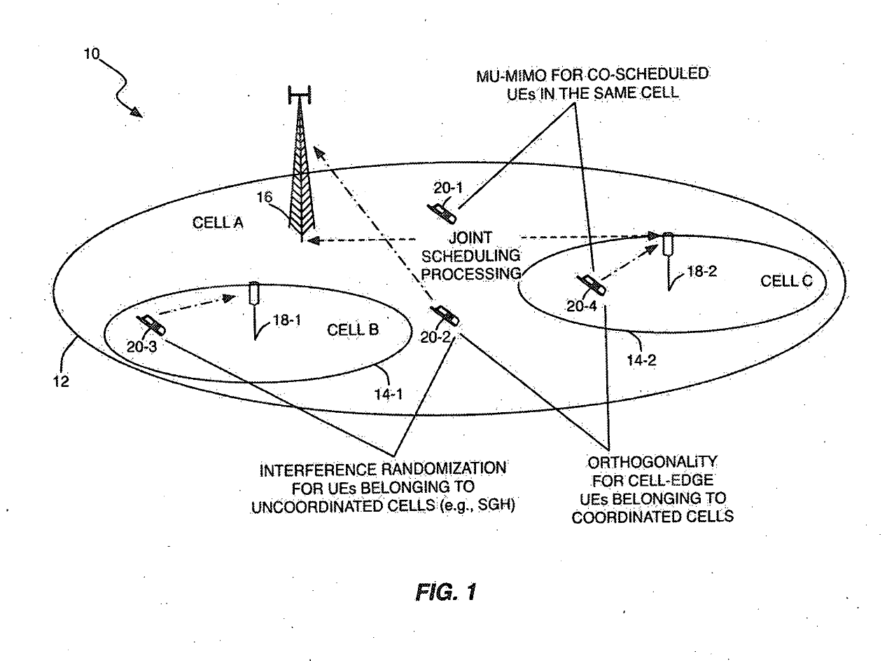

Although the described solutions may be implemented in any appropriate type of telecommunication system supporting any suitable communication standards and using any suitable components, particular embodiments of the described solutions may be implemented in an LTE network, such as that illustrated in FIG. 1.

The example network 10 represents an LTE-based het-net deployment, where a macro cell 12, “Cell A”, that is overlaid with two pico cells 14-1 and 14-2, which are also labeled as “Cell B” and “Cell C”, respectively. Note that the term “pico cell 14” and “pico cells 14” will be used generically, unless there is a need to use suffixes “−1”, “−2”, and so on, for distinction.

The diagram depicts a macro base station 16 providing coverage in the macro cell 12, and it will be understood that the macro base station 16 comprises, e.g., an eNodeB in the LTE context. Similarly, one sees pico base stations 18-1 and 18-2 providing coverage in the pico cells 14-1 and 14-2, respectively. These pico base stations 18 may be understood as representing lower-power access points, such as Home eNodeBs, or other smaller-coverage types of access points.

The depicted arrangement provides communication services to a number of wireless devices 20 operating within the various cellular coverage areas. Merely by way of example, the following UEs or other wireless devices are depicted: 20-1, 20-2, 20-3, and 20-4. One sees that wireless devices 20-1 and 20-2 may be operating as co-scheduled users in a MU-MIMO context, that wireless devices 20-2 and 20-4 may be operating as cell-edge UEs belonging to coordinated cells 12 and 14-2, for orthogonalization of their DMRS transmissions, among other aspects of such coordination, while the wireless devices 20-2 and 20-3 may be operating with respect to each other as UEs belonging to uncoordinated cells, where interference randomization is used to mitigate interference between their respective DMRS transmissions.

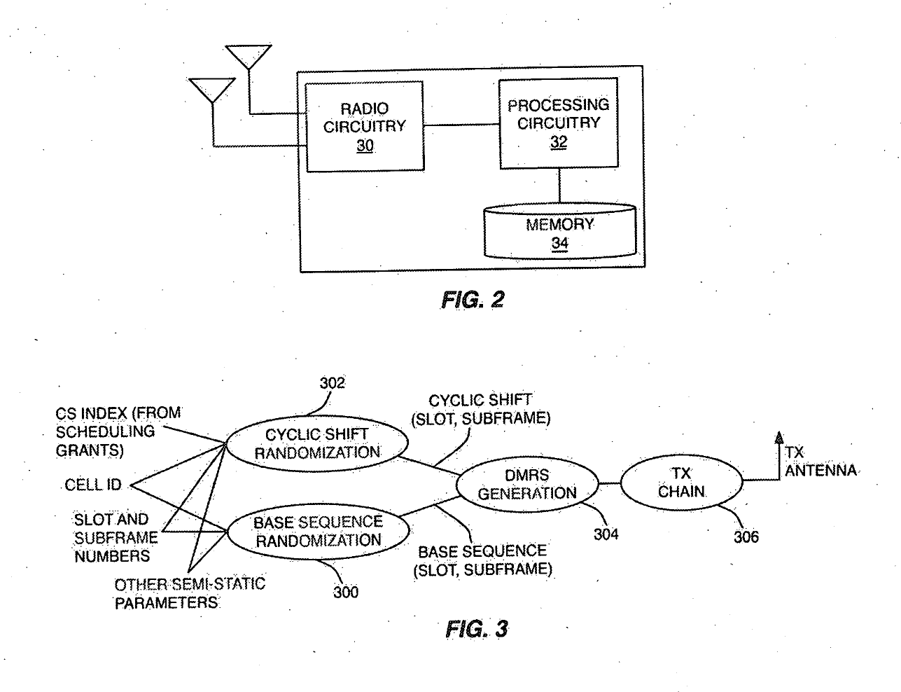

The example network 10 may further include any additional elements suitable to support communication between the wireless devices 20 or between a wireless device 20 and another communication device, such as a landline telephone, which is not shown. Although the illustrated wireless devices 20 may represent communication devices that include any suitable combination of hardware and/or software, a non-limiting embodiment of a wireless device 20 is depicted in FIG. 2.

As shown in FIG. 2, the example wireless device 20 includes radio circuitry 30 with one or more associated antennas, processing circuitry 32, and memory 34, which may comprise both program and working data storage. The radio circuitry 30 may comprise RF circuitry and include or be associated with baseband processing circuitry, which may be implemented in the processing circuitry 32.

In some embodiments, some or all of the functionality described herein for device-side DMRS generation and transmission is provided by the processing circuitry 32 executing instructions stored on a computer-readable medium, such as the memory 34. Alternative embodiments of the wireless device 20 may include additional components beyond those shown in the diagram, and such additional elements may be responsible for providing certain aspects of the wireless device's functionality, including any of the functionality described above and/or any functionality necessary to support the solution(s) described above.

As shown in FIG. 3, the processing circuitry 32 in one or more embodiments is configured to generate demodulation reference signals using base sequence randomization and CS randomization—which are depicted as being performed in functional processing elements 300 and 302, respectively. A DMRS generation function 304 generates demodulation reference symbols according to the randomizations, and the resulting demodulation reference symbols are transmitted via a “Tx chain” 306 and associated antenna(s), where it will be understood that the Tx chain 306 is implemented by radio circuitry 30.

With the above implementation examples in mind, a wireless device 20 in one or more embodiments taught herein is configured to perform a method of transmitting demodulation reference symbols that includes the device selectively disabling cyclic shift hopping within repetitions of an orthogonal cover code that is applied to demodulation reference symbol transmissions by the device. That is, as an optional operational configuration, the wireless device 20 uses the same CS value for all demodulation reference symbols transmitted within one repetition of the orthogonal cover code being used to cover its DMRS transmissions. For the LTE example case where a UE transmits two demodulation reference symbols in a subframe and the orthogonal cover code has a complementary length of two—i.e., one element per demodulation reference symbol transmitted within the subframe—it will be understood that each repetition of the orthogonal cover code “covers” the transmission of two demodulation reference symbols.

Thus, when cyclic shift hopping within repetitions of the orthogonal cover code is disabled, the method includes the wireless device 20 applying a same cyclic shift value to individual demodulation reference symbols transmitted within each repetition of the orthogonal cover code, so that all demodulation reference symbols transmitted for one repetition of the orthogonal cover code have the same cyclic shift value applied to them. Conversely, when cyclic shift hopping within repetitions of the orthogonal cover code is enabled, the method includes the wireless device 20 applying a different cyclic shift value to individual demodulation reference symbols transmitted within each repetition of the orthogonal cover code, so that all demodulation reference symbols transmitted for one repetition of the orthogonal cover code have different cyclic shift values applied to them.

Notably, even when cyclic shift hopping within each repetition of the orthogonal cover code is disabled, the method may still include changing the cyclic shift value applied over successive repetitions of the orthogonal cover code. In the LTE example case, such operation means that the cyclic shift value applied to the demodulation reference symbols transmitted in one subframe will differ from the cyclic shift value applied to the demodulation reference symbols transmitted in another subframe. For example, the wireless device 20 may change the cyclic shift value applied over successive repetitions of the orthogonal cover code by pseudo-randomly changing the cyclic shift value over successive repetitions of the orthogonal cover code, e.g., the cyclic shift used for DMRS transmissions over successive subframes pseudo-randomly changes.

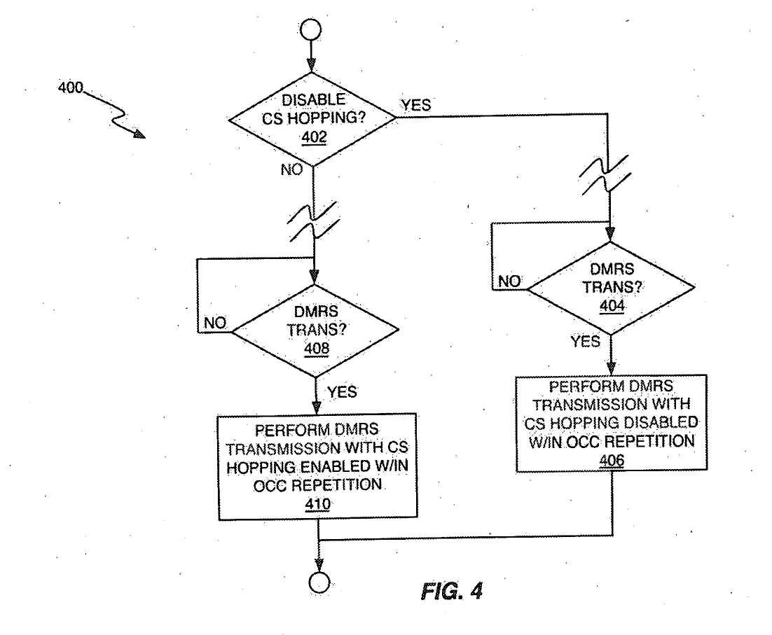

Regardless, an advantageous aspect of the above method is that respective elements of the orthogonal cover code are applied to respective ones of the individual demodulation reference symbols transmitted in each repetition of the orthogonal cover code, while the same cyclic shift value is used for all demodulation symbols transmitted within each given repetition of the orthogonal cover code. An example of the method is depicted as method 400 in FIG. 4.

One sees the wireless device 20 optionally disabling cyclic shift hopping within repetitions of the orthogonal cover code it is using to cover its DMRS transmissions (Block 402), where a “YES” from Block 402 means that cyclic shift hopping is disabled within individual repetitions of the orthogonal cover code, which means that the same cyclic shift value will be applied to each demodulation reference symbol transmitted within a given repetition of the orthogonal cover code. Thus, when it is time to perform a next DMRS transmission (“YES” from Block 404), the wireless device 20 performs that transmission using a fixed cyclic shift value for all of the demodulation reference symbols transmitted within a current repetition of the orthogonal cover code (Block 406).

Conversely, a “NO” from Block 402 means that cyclic shift hopping is enabled within individual repetitions of the orthogonal cover code, which means that the cyclic shift value will be changed for each demodulation reference symbol transmitted within a given repetition of the orthogonal cover code. Thus, when it is time to perform a next DMRS transmission (“YES” from Block 408), the wireless device 20 performs that transmission using a changing cyclic shift value for each of the demodulation reference symbols transmitted within a current repetition of the orthogonal cover code (Block 410).

In some embodiments, the method 400 includes, in each repetition of the orthogonal cover code, transmitting a same demodulation reference symbol multiple times but with a different element of the orthogonal cover code applied each time. Of course, such embodiments may further include changing the demodulation reference symbol over successive repetitions of the orthogonal cover code, so that different demodulation reference symbols are repeated in different repetitions of the orthogonal cover code.

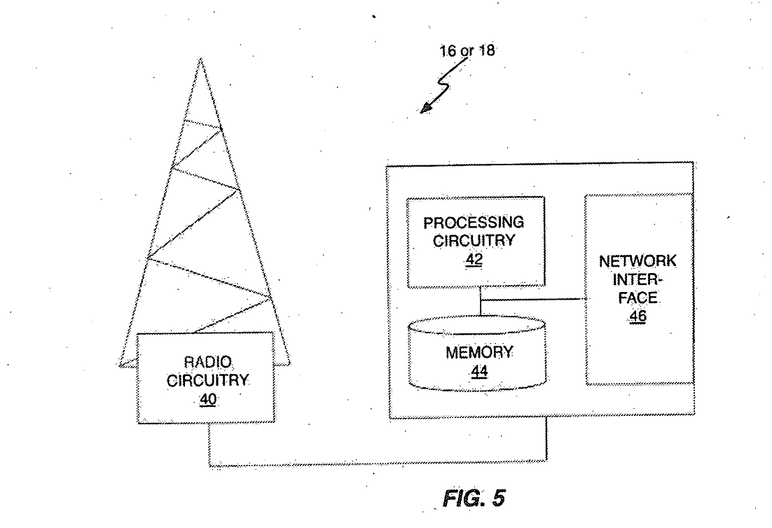

Turning to the network-side of such operations, FIG. 5 illustrates an example network node, e.g., a base station 16 or 18 as introduced in FIG. 1. The illustrated network node 16 or 18 includes any suitable combination of hardware and/or software.

In the illustrated example, the network node 16 or 18 includes radio circuitry 40 and one or more associated antennas, processing circuitry 42, program and working data memory 44, and one or more network interfaces 46, for communication with other network nodes 16 or 18 and/or with other types of network nodes. The processing circuitry 42 may comprise RF circuitry and baseband processing circuitry (not explicitly noted in the illustration).

In particular embodiments, some or all of the functionality described herein for a network base station, relay or other such node, may be provided by the processing circuitry 42 executing instructions stored on a computer-readable medium, such as the memory 44. Alternative embodiments of the network node 16 or 18 may include additional components responsible for providing additional functionality, including any of the functionality identified herein and/or any functionality necessary to support the network-side solutions described herein.

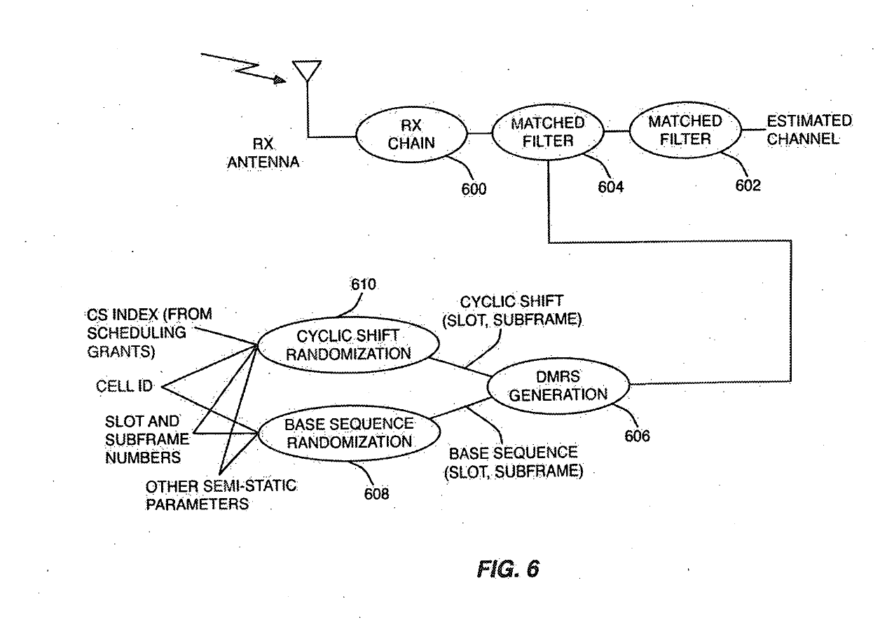

As shown in FIG. 6, the network node 16 or 18 is configured to estimate the channel of wireless device 20, based on receiving demodulation reference symbols from the wireless device 20 via Rx antenna(s) and an Rx “chain” 600, corresponding to the processing circuitry 42 operating in conjunction with the radio circuitry 40. The processing circuitry 42 is configured to perform channel estimation 602 based on matched filtering 604. To this end, the network node 16 or 18 is configured to perform DMRS generation 606, based on base sequence and cyclic shift randomization processing 608 and 610, respectively.

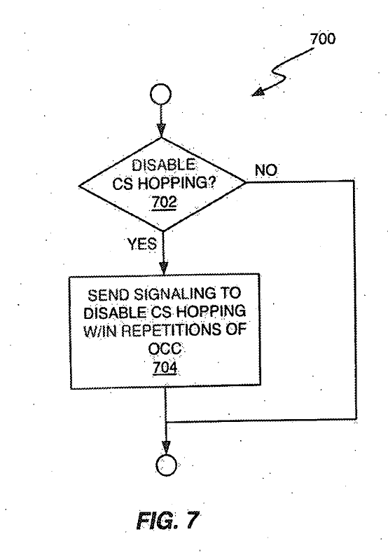

In a general example, the network node 16 or 18 is configured to implement a method 700, as illustrated in FIG. 7. For simplicity of illustration and discussion, the method 700 is presented in terms of a single wireless device 20, but it should be understood as being applicable to essentially any number of wireless devices 20—e.g., the same method 700 can be applied jointly or separately to multiple wireless devices 20 at the same time, or at different times.

The method 700 includes determining whether a wireless device 20 should disable cyclic shift hopping within repetitions of the orthogonal cover code applied by the wireless device 20 to its DMRS transmissions (Block 702). If so (“YES” from Block 702), then the method 700 continues with the network node 16 or 18 sending signaling to the wireless device 20, to cause the wireless device 20 to disable cyclic shift hopping within repetitions of the orthogonal cover code (Block 704). Of course, the wireless device 20 may still be configured to dynamically change the cyclic shift applied by it over successive repetitions of the orthogonal cover code, so that different DMRS transmissions in different repetitions of the orthogonal cover code have different cyclic shift values applied to them.

As an example, the step of determining that the wireless device 20 should disable cyclic shift hopping within individual repetitions of the orthogonal cover code comprises identifying that the wireless device 20 is or will be co-scheduled on overlapping uplink resources with one or more other wireless devices 20 connected to the wireless communication network 10.

In a particular example, the above step of determining comprises determining that the wireless device 20 is a first MU-MIMO user in the wireless communication network 10 that is or will be co-scheduled on overlapping uplink resources with a second MU-MIMO user in the wireless communication network 10. In an example case, the first MU-MIMO user is in a first cell 12, 14 of the wireless communication network 10 and the second MU-MIMO user is in a neighboring, second cell 12, 14 of the wireless communication network 10, and the step of determining is based on evaluating uplink scheduling information for the first and second cells 12, 14.

In at least one embodiment of the method 700, the wireless communication network 10 comprises an LTE network, and the method includes processing DMRS transmissions received from the wireless device 20 in dependence on whether the wireless device 20 has or has not disabled cyclic shift hopping within repetitions of the orthogonal cover code applied by the wireless device 20 to its DMRS transmissions.

Compared to known solutions and techniques, particular embodiments disclosed herein enable MU-MIMO and inter-cell interference orthogonalization for reference signals while retaining interference randomization on at least a subframe basis. In an example of one such embodiment, a wireless device 20 is configured to apply an orthogonal cover code to both slots of a subframe. For DMRS transmission, the wireless device 20 is configured to: generate a demodulation reference symbol using a base sequence and a cyclic shift and transmit it in a first slot of the subframe; and then transmit a demodulation reference symbol in a second slot of the subframe using the same base sequence and the same cyclic shift—i.e., the same cyclic shift offset is maintained for both demodulation reference symbols transmitted in the subframe.

The second demodulation reference symbol may be a repeat of the first one, and the wireless device 20 “covers” the two symbol transmissions using an orthogonal cover code that is applied to the subframe. The wireless device 20 also may be configured to recognize implicitly that cyclic shift hopping should be disabled for the two demodulation reference symbols transmitted within one subframe, based on the indicated use of a randomized base sequence hopping pattern, where the base sequence is randomized on a subframe basis but the same base sequence is repeated in each slot of a given subframe. On the network side, a base station 16 or 18 thus may be configured to implicitly indicate that cyclic shift hopping should be disabled, at least within subframes, based on indicating use of the randomized base sequence hopping pattern.

Modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-24. (canceled)

25. A method of transmitting demodulation reference symbols from a wireless device, said method comprising:
selectively disabling cyclic shift hopping within repetitions of an orthogonal cover code that is applied to demodulation reference symbol transmissions by the wireless device; and
when cyclic shift hopping within repetitions of the orthogonal cover code is disabled, applying a same cyclic shift value to individual demodulation reference symbols transmitted within each repetition of the orthogonal cover code, so that all demodulation reference symbols transmitted for one repetition of the orthogonal cover code have the same cyclic shift value applied to them; and
when cyclic shift hopping within repetitions of the orthogonal cover code is enabled, applying a different cyclic shift value to individual demodulation reference symbols transmitted within each repetition of the orthogonal cover code, so that all demodulation reference symbols transmitted for one repetition of the orthogonal cover code have different cyclic shift values applied to them.

26. The method of claim 25, further comprising, when cyclic shift hopping within each repetition of the orthogonal cover code is disabled, changing the cyclic shift value applied over successive repetitions of the orthogonal cover code.

27. The method of claim 26, wherein changing the cyclic shift value applied over successive repetitions of the orthogonal cover code comprises pseudo-randomly changing the cyclic shift value over successive repetitions of the orthogonal cover code.

28. The method of claim 25, wherein respective elements of the orthogonal cover code are applied to respective ones of the individual demodulation reference symbols transmitted in each repetition of the orthogonal cover code, and wherein the method includes, in each repetition of the orthogonal cover code, transmitting a same demodulation reference symbol multiple times but with a different element of the orthogonal cover code applied each time.

29. The method of claim 28, further comprising changing the demodulation reference symbol over successive repetitions of the orthogonal cover code, so that different demodulation reference symbols are repeated in different repetitions of the orthogonal cover code.

30. The method of claim 25, further comprising determining that cyclic shift hopping is to be disabled based on a modified pseudo-random base sequence hopping pattern being used, wherein a same base sequence is repeated on all slots within a subframe over which the orthogonal cover code applies.

31. A wireless device configured for operation in a wireless communication network and comprising:
radio circuitry configured for transmitting demodulation reference symbols to one or more reception points in the wireless communication network; and
processing circuitry operatively associated with the radio circuitry and configured to:
selectively disable cyclic shift hopping within repetitions of an orthogonal cover code that is applied to demodulation reference symbol transmissions by the wireless device; and
when cyclic shift hopping within repetitions of the orthogonal cover code is disabled, apply a same cyclic shift value to individual demodulation reference symbols transmitted within each repetition of the orthogonal cover code, so that all demodulation reference symbols transmitted for one repetition of the orthogonal cover code have the same cyclic shift value applied to them; and
when cyclic shift hopping within repetitions of the orthogonal cover code is enabled, apply a different cyclic shift value to individual demodulation reference symbols transmitted within each repetition of the orthogonal cover code, so that all demodulation reference symbols transmitted for one repetition of the orthogonal cover code have different cyclic shift values applied to them.

32. The wireless device of claim 31, wherein, when cyclic shift hopping within each repetition of the orthogonal cover code is disabled, the processing circuitry is configured to change the cyclic shift value applied over successive repetitions of the orthogonal cover code.

33. The wireless device of claim 32, wherein the processing circuitry is configured to change the cyclic shift value applied over successive repetitions of the orthogonal cover code based on being configured to pseudo-randomly change the cyclic shift value over successive repetitions of the orthogonal cover code.

34. The wireless device of claim 31, wherein respective elements of the orthogonal cover code are applied to respective ones of the individual demodulation reference symbols transmitted in each repetition of the orthogonal cover code, and wherein the processing circuitry is configured to, in each repetition of the orthogonal cover code, transmit a same demodulation reference symbol multiple times but with a different element of the orthogonal cover code applied each time.

35. The wireless device of claim 34, wherein the processing circuitry is configured to change the demodulation reference symbol over successive repetitions of the orthogonal cover code, so that different demodulation reference symbols are repeated in different repetitions of the orthogonal cover code.

36. The wireless device of claim 31, wherein the processing circuitry is configured to determine that cyclic shift hopping is to be disabled based on a modified pseudo-random base sequence hopping pattern being used, wherein a same base sequence is repeated on all slots within a subframe over which the orthogonal cover code applies.

37. A method of controlling a wireless device operating in a wireless communication network, said method implemented in a network node and comprising:
determining that the wireless device should disable cyclic shift hopping within repetitions of an orthogonal cover code applied by the wireless device to demodulation reference symbol, “DMRS”, transmissions by the wireless device; and
sending signaling to the wireless device, to cause the wireless device to disable cyclic shift hopping within said repetitions of the orthogonal cover code.

38. The method of claim 37, wherein said step of determining comprises identifying that the wireless device is or will be co-scheduled on overlapping uplink resources with one or more other wireless devices connected to the wireless communication network.

39. The method of claim 37, wherein said step of determining comprises determining that the wireless device is a first Multi-User Multiple-Input-Multiple-Output, “MU-MIMO”, user in the wireless communication network that is or will be co-scheduled on overlapping uplink resources with a second MU-MIMO user in the wireless communication network.

40. The method of claim 39, wherein the first MU-MIMO user is in a first cell of the wireless communication network and the second MU-MIMO user is in a neighboring, second cell of the wireless communication network, and wherein said step of determining is based on evaluating uplink scheduling information for the first and second cells.

41. The method of claim 37, wherein the wireless communication network comprises a Long Term Evolution, “LTE”, network, and further comprising processing DMRS transmissions received from the wireless device in dependence on whether the wireless device has or has not disabled cyclic shift hopping within repetitions of the orthogonal cover code applied by the wireless device to its DMRS transmissions.

42. The method of claim 37, wherein sending the signaling to the wireless device comprises implicitly signaling that cyclic shift hopping is to be disabled, based on indicating a modified pseudo-random base sequence hopping pattern, wherein a same base sequence is to be repeated by the wireless device on all slots within a subframe over which the orthogonal cover code applies.

43. A network node configured for operation in a wireless communication network and comprising:
radio circuitry configured to transmit signals to a wireless device connected to the wireless communication network through the network node and to receive signals from the wireless device;
processing circuitry operatively associated with the radio circuitry and configured to:
determine that the wireless device should disable cyclic shift hopping within repetitions of an orthogonal cover code applied by the wireless device to demodulation reference symbol, “DMRS”, transmissions by the wireless device; and
send signaling to the wireless device, to cause the wireless device to disable cyclic shift hopping within said repetitions of the orthogonal cover code.

44. The network node of claim 43, wherein the processing circuitry is configured to determine that the wireless device should disable cyclic shift hopping within repetitions of the orthogonal cover code based on being configured to identify that the wireless device is or will be co-scheduled on overlapping uplink resources with one or more other wireless devices connected to the wireless communication network.

45. The network node of claim 43, wherein the processing circuitry is configured to determine that the wireless device should disable cyclic shift hopping within individual repetitions of the orthogonal cover code based on being configured to determine that the wireless device is a first Multi User Multiple-Input-Multiple-Output, “MU-MIMO”, user in the wireless communication network that is or will be co-scheduled on overlapping uplink resources with a second MU-MIMO user in the wireless communication network.

46. The network node of claim 45, wherein the first MU-MIMO user is in a first cell of the wireless communication network and the second MU-MIMO user is in a neighboring, second cell of the wireless communication network, and wherein the processing circuitry is configured to determine that the first and second MU-MIMO users are co-scheduled on overlapping uplink resources based on being configured to evaluate uplink scheduling information for the first and second cells.

47. The network node of claim 43, wherein the wireless communication network comprises a Long Term Evolution, “LTE”, network, and wherein the processing circuitry is configured to process the DMRS transmissions received from the wireless device in dependence on whether the wireless device has or has not disabled cyclic shift hopping within repetitions of the orthogonal cover code applied by the wireless device to its DMRS transmissions.

48. The network node of claim 43, wherein the processing circuitry is configured signal to the wireless device implicitly that cyclic shift hopping is to be disabled, based on indicating a modified pseudo-random base sequence hopping pattern, wherein a same base sequence is to be repeated by the wireless device on all slots within a subframe over which the orthogonal cover code applies.
